(19) United States
(12) Patent Application Publication
(10) Pub. No.: US 2011/0061976 A1
(43) Pub. Date: Mar. 17, 2011

(54) Battery counterweighted elevator

(76) Inventor: James L. Tiner, Lakeway, TX (US)

(21) Appl. No.: 12/585,566

(22) Filed: Sep. 17, 2009

(51) Int. Cl. B66B 11/00; B66B 7/00; B66B 9/02; B66B 11/08

(52) U.S. Cl. 187/254; 187/404; 187/267

(57) ABSTRACT

The battery counterweighted elevator is adapted for rack and pinion or cable traction elevators. The elevator uses electrical power from a solar cell array to charge or recharge storage batteries, which, in turn, provide the electrical power to drive the elevator. The storage batteries serve as counterweights for at least a substantial portion of the weight of the elevator car, and travel up and down opposite the car. A traveling cable connects the elevator car with the batteries in the counterweight in the case of the rack and pinion elevator, with the cable providing power to the drive motor situated with the car and also providing control of the system from the car. The cable traction elevator has a traveling control cable extending to a fixed junction box, with power supplied from the batteries to the junction box and thence to the fixed motor at the top of the hoistway.

### BACKGROUND OF THE INVENTION

1. Field of the Invention

The present invention relates generally to elevator systems, and particularly to a battery counterweighted elevator using the rack and pinion or cable traction drive principle of operation, wherein a counterweight is provided substantially by electrical storage batteries used to power the elevator.

2. Description of the Related Art

Elevators generally use one of three operating principles, i.e., hydraulic, cable traction, or rack and pinion operation. Hydraulic elevators are limited to a relatively few stories of lift height, but cable traction and particularly rack and pinion systems are relatively unlimited as to the height of the building structures in which they may be installed. While most people are more familiar with elevator systems installed in taller office structures and the like, elevators, and particularly rack and pinion elevators, are often installed in tall industrial structures to facilitate maintenance and repair of such structures and the equipment therein and thereon.

An example of such is found in large wind generators, where the tower may extend to well over one hundred feet above the surface in order to provide clearance for the large diameter wind blades. Remotely located radio and television broadcast towers, weather and aviation radar towers, and similar structures are also excellent candidates for such industrial elevators. Obviously, the taller the structure, the more power is required to drive the elevator to the top. While it is possible to recover some of that power through regenerative braking on the descent, it is not possible to recover all of the power expended in lifting the elevator. The power requirement may be minimized by using counterweights approximately equal to the empty weight of the elevator car and its equipment, but conventionally most counterweight systems comprise dead weight using heavy metal ballast, concrete, or the like.

While most taller structures have (or supply, in the case of wind generators) electrical power, the electrical power is generally intended to operate equipment or (in the case of wind generators) to be delivered commercially to other users. Using the electrical power intended for other use to drive an elevator is generally regarded as inefficient, but oftentimes there is no other suitable source of elevator power available. While solar power generation has been considered for powering remotely situated electrical devices, some means of storing the generated solar power until it is needed is required for such systems.

Thus, a battery counterweighted elevator solving the aforementioned problems is desired.

### SUMMARY OF THE INVENTION

The battery counterweighted elevator may utilize either the rack and pinion or cable traction principle of operation. Either elevator type incorporates a cable-suspended counterweight assembly to reduce power requirements. Electrical power for powering the elevator is preferably provided primarily by a solar power source, although electrical power from some other external source, e.g., conventional electrical power grid, may also be provided to supplement the solar power source. Regardless of the source, the electrical power is used to charge (or recharge) a number of electrical storage batteries. The batteries also serve as the counterweight for the elevator car and its attached equipment.

The rack and pinion elevator incorporates at least one drive motor, reduction gearing, and safety systems and controls within or on the elevator car or cab. The motor drives a pinion that engages the rack that extends along the height of the elevator hoistway. A traveling cable extends from a fixed electrical junction box adjacent to the elevator hoistway to the batteries in the counterweight to provide electrical power for recharging the batteries. Electrical power is provided to the junction box primarily by solar power or, alternatively, by supplemental power from a conventional electrical power grid. A power and communications traveling cable extends from the junction box to the elevator car to provide power to the drive motor and control of that power from the cab.

The motive power for the cable traction elevator is disposed at the top of the elevator hoistway, and drives a pulley or sheave system controlling a cable connected to the top of the elevator car. Since the drive motor is fixed at the top of the hoistway or tower, the power cable from the fixed junction box is also fixed and does not travel as it does in the case of the rack and pinion elevator. However, the traveling counterweight with its batteries is connected to the junction box via a traveling power cable, which may incorporate a line for charging the batteries as well. Another traveling cable extends from the elevator car to the junction box to provide control of the elevator from within the car and to provide communications from the car. The junction box receives primary power for recharging the batteries from a solar power source, and alternative power from a conventional electric power grid or other suitable source if the solar power is insufficient.

These and other features of the present invention will become readily apparent upon further review of the following specification and drawings.

### BRIEF DESCRIPTION OF THE DRAWINGS

FIG. 1 is a schematic elevation view of a first embodiment of a battery counterweighted elevator according to the present invention, showing the counterweight in a rack and pinion elevator system.

FIG. 2 is a schematic elevation view of a second embodiment of a battery counterweighted elevator according to the present invention, showing the counterweight in a cable traction elevator system.

Similar reference characters denote corresponding features consistently throughout the attached drawings.

### DETAILED DESCRIPTION OF THE PREFERRED EMBODIMENTS

The battery counterweighted elevator comprises different embodiments of an electrically powered elevator using electric storage batteries as the power supply. The batteries are recharged from another electrical source, as needed. The batteries are installed in a counterweight used to offset at least some of the weight of the elevator car and its associated equipment. The battery counterweighted elevator system may be applied to either a rack and pinion or a cable traction elevator operating system.

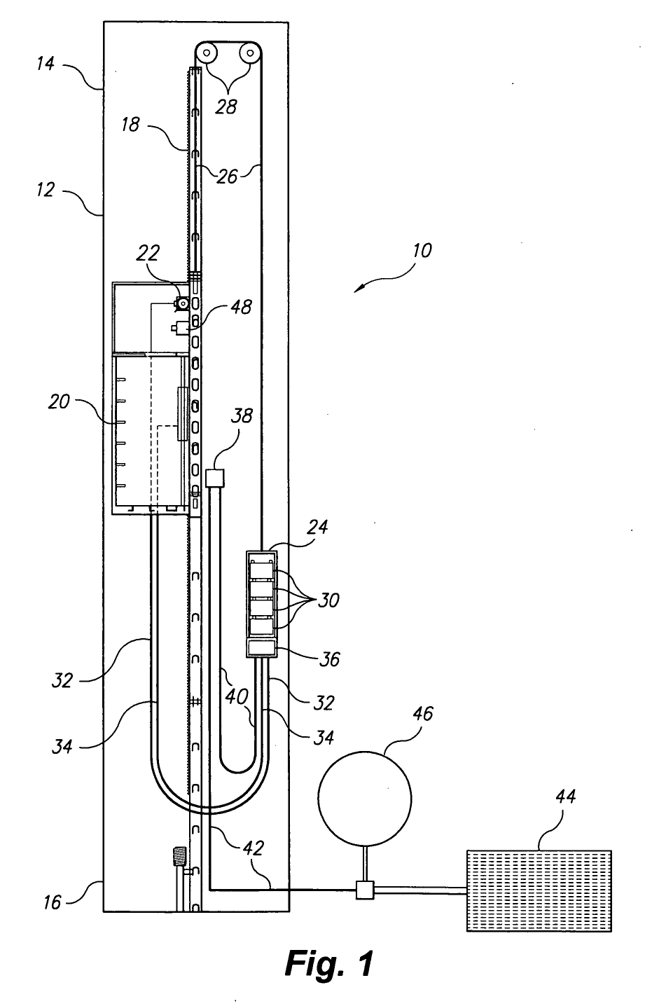

FIG. 1 of the drawings provides a schematic illustration of a rack and pinion type elevator system 10 incorporating the battery counterweight. The rack and pinion elevator system 10 has a hoistway 12 with an upper end 14 and opposite lower end 16. The hoistway includes a linear toothed rack 18 extending from the upper end 14 to the lower end 16. An elevator car 20 is installed in the hoistway 12 and travels up and down the hoistway 12, as is conventional in such rack and pinion elevator systems. The elevator car 20 has at least one elevator drive motor 22 installed therewith, e.g., atop the car 20, as shown in FIG. 1, with the drive motor 22 driving a pinion that engages the rack 18 to drive the elevator up the rack and hoistway 12 when commanded. Such rack and pinion systems are conventional, and need not be shown and described in further detail herein.

A counterweight 24 is suspended in the hoistway 12 by a cable 26. The counterweight cable 26 extends from the top of the elevator car 20 upwardly to pass over a passive pulley assembly 28 at the upper end 14 of the hoistway 12, and thence downwardly to the counterweight 24. The counterweight 24 thus travels in a direction opposite the direction of travel of the elevator car 20, e.g., the counterweight travels downwardly when the car is moving upwardly. The counterweight 24 carries sufficient weight to balance or offset at least a substantial portion of the weight of the empty elevator car 20, i.e., at least more than half of the weight of the empty car 20. The weight of the counterweight 24 may be adjusted to approach one hundred percent of the empty weight of the car 20, if desired.

A substantial portion of the weight of the counterweight 24 comprises one or more (preferably several) electric storage batteries 30, disposed on or within the counterweight 24. A traveling power cable 32 extends between the elevator car 20 and the counterweight 24, the cable 32 hanging in a catenary arc below the car 20 and counterweight 24. The power cable 32 provides electrical power from the storage batteries 30 within the counterweight 24 to the elevator drive motor 22 installed in or on the car 20.

Another traveling cable may be physically attached or linked to the power cable 32, or may be suspended separately from the power cable 32, if desired. The additional traveling cable comprises a control and communications cable 34 that extends between the elevator car 20 and the counterweight 24. A control panel within the elevator car 20 is used to transmit signals through or along this control and communications cable 34 to control the power output of the batteries 30 within or on the counterweight 24, thus controlling movement of the elevator car 20.

The counterweight 24 preferably also contains a battery charger 36. The charger 36 could be located elsewhere, but as its weight is substantial due to the output amperage required, it is preferably located with the counterweight 24 in order to provide additional weight therein. The charger 36 receives electrical power from a junction box 38 immovably affixed within or adjacent to the hoistway 12, with a traveling battery charger power cable 40 extending between the mobile counterweight 24 and the stationary electrical junction box 38.

The junction box 38 receives electrical power from an external source via a fixed cable 42, which provides electrical power to the battery charger 36 and thence to the batteries 30 to keep them charged. The battery counterweighted elevator 10 is particularly well suited for installations in or on relatively remote towers and the like. Such installations may have limited electrical power available. Accordingly, the junction box 38 preferably receives electrical power from a solar panel array 44. Solar panel arrays require significant area to put out adequate electrical power, but the battery counterweighted elevator is anticipated to be operated infrequently. Thus, the batteries 30 may be recharged slowly over a relatively long period of time before the next elevator operation occurs. However, the system may be connected into the conventional electric power supply grid 46 if it is anticipated that additional electrical power may be required for heavy usage of the elevator 10 or for other reasons.

Additional subsystems providing further efficiency and safety may be included in the system, as desired. For example, some of the energy expended in raising the elevator car 20 may be recovered when the car descends if a motor/generator is used as the elevator drive motor 22. Such motor/generators are conventional and well known for use in systems where a reverse electromagnetic force occurs when the motor is driven, rather than driving the system, as when elevator is descending. The electrical energy generated under such conditions may be delivered to the battery charger 36 via the traveling power cable 32, to deliver power by regenerative braking.

The battery counterweighted elevator system 10 also preferably includes additional safety subsystems, e.g., an overspeed safety brake and speed governor 48. Such systems are conventional, and accordingly need not be described in further detail herein.

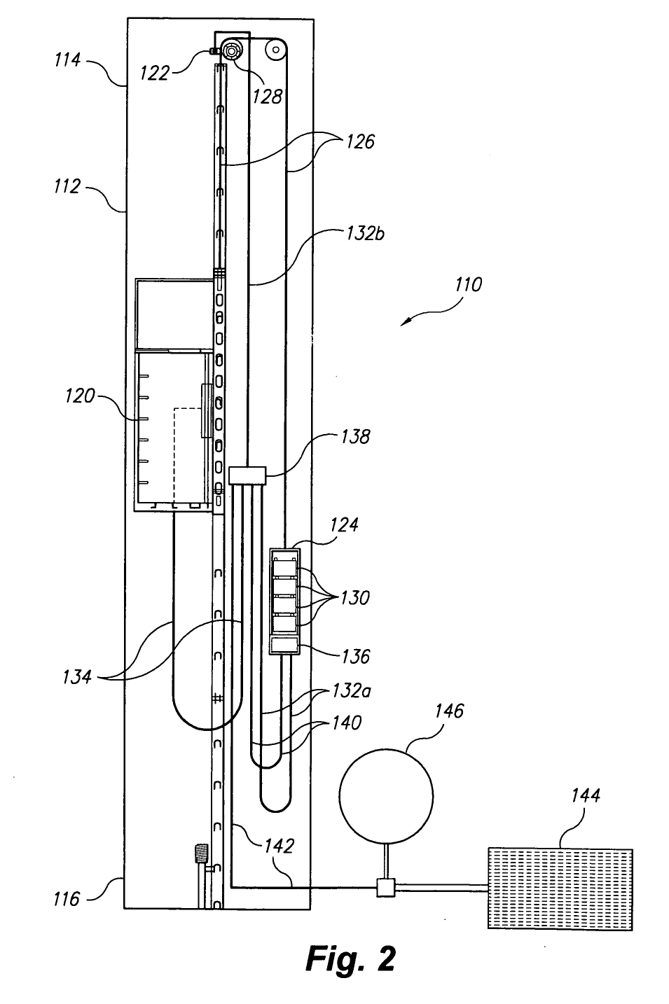

FIG. 2 of the drawings is a schematic elevation view of a cable traction elevator system 110 incorporating a battery counterweight apparatus. The cable traction elevator system 110 has a hoistway 112 with an upper end 114 and opposite lower end 116. An elevator car 120 is installed in the hoistway 112 and travels up and down the hoistway 112, as is conventional in such cable traction elevator systems. The elevator car 120 is suspended by a lift cable 126 that extends from the top of the elevator car 120 upwardly to pass over or through a drive pulley and sheave system 128 at the upper end 114 of the hoistway 112. The drive pulley and sheave system 128 is powered by an elevator drive motor 122 installed therewith. The lift cable 126 continues over and through the drive pulley and sheave system 128 and continues downwardly, where it attaches to a counterweight 124. The counterweight 124 thus travels in a direction opposite the direction of travel of the elevator car 120, e.g., the counterweight travels downwardly when the car is moving upwardly. The counterweight 124 carries sufficient weight to balance or offset at least a substantial portion of the weight of the empty elevator car 120, i.e., at least more than half of the weight of the empty car 120. The weight of the counterweight 124 may be adjusted to approach one hundred percent of the empty weight of the car 120, if desired.

A substantial portion of the weight of the counterweight 124 comprises one or more (preferably several) electric storage batteries 130, disposed on or within the counterweight 124. A traveling power cable 132a extends from the counterweight 124 to a junction box 138 immovably affixed within or adjacent to the hoistway 112. The cable 132a hangs in a catenary arc below the junction box 138 and counterweight 124. A fixed or stationary continuation 132b of this cable continues from the junction box 138 to the elevator drive motor 122 located at the upper end 114 of the hoistway. The power cable 132a and 132b provides electrical power from the storage batteries 130 within the counterweight 124 to the elevator drive motor 122 installed at the upper end 114 of the hoistway 112 to drive the drive pulley and sheave system 128, thereby lifting the elevator car 120.

A control and communications traveling cable 134 extends between the elevator car 120 and the electrical junction box 138. A battery charger power and communications traveling cable 140 extends between the junction box 138 and the counterweight 124. A control panel within the elevator car 120 is used to transmit signals through or along this control and communications cable 134 to the junction box 138 and thence through the charger power and communications cable 140 to the counterweight 124 to control the power output of the batteries 130 within or on the counterweight 124, thus controlling movement of the elevator car 120. The traveling charger power and communications cable 140 may be physically attached or linked to the traveling portion of the power cable 132a, or may be suspended separately from the power cable 132a traveling portion, if desired.

The counterweight 124 preferably also contains a battery charger 136. The charger 136 could be located elsewhere, but as its weight is substantial due to the output amperage required, it is preferably located with the counterweight 124 in order to provide additional weight therein. The charger 136 receives electrical power from the junction box 38 via the traveling battery charger power cable 140 extending between the mobile counterweight 124 and the stationary electrical junction box 138.

The junction box 138 receives electrical power from an external source via a fixed cable 142, to provide electrical power to the battery charger 136 and thence to the batteries 130 to keep them charged. The battery counterweighted cable traction elevator 110 is particularly well suited for installations in or on relatively remote towers and the like. Such installations may have limited electrical power available. Accordingly, the junction box 138 preferably receives electrical power from a solar panel array 144. Solar panel arrays require significant area to put out adequate electrical power, but the battery counterweighted elevator is anticipated to be operated infrequently, thus allowing the batteries 130 to be recharged slowly over a relatively long period of time before the next elevator operation occurs. However, the system may be connected into a conventional electric power supply grid 146 if it is anticipated that additional electrical power may be required for heavy usage of the elevator or for other reasons.

Additional subsystems providing further efficiency and safety may be included in the system, as desired. For example, some of the energy expended in raising the elevator car 120 may be recovered when the car descends if a motor/generator is used as the elevator drive motor 122. Such motor/generators are conventional and well known for use in systems where a reverse electromagnetic force occurs when the motor is driven, rather than driving the system, as when the elevator is descending. The electrical energy generated under such conditions may be delivered to the battery charger 136 via the fixed and traveling power cables 132a and 132b to recharge the battery charger 136 by regenerative braking.

The battery counterweighted cable traction elevator system 110 also preferably includes additional safety subsystems to prevent excessive speed or free fall of the elevator car 120 in the event of lift cable breakage or other catastrophic failure of the system. Such systems are conventional, and accordingly need not be described in further detail herein.

It is to be understood that the present invention is not limited to the embodiments described above, but encompasses any and all embodiments within the scope of the following claims.

I claim:

1. A battery counterweighted elevator, comprising:
an elevator hoistway having an upper end and a lower end opposite the upper end;
an elevator car disposed along the hoistway, the elevator car being adapted to travel up and down along the hoistway;
at least one elevator drive motor selectively providing motive force to the elevator car;
a counterweight connected to the elevator car, the counterweight traveling up and down in a direction opposite the elevator car;
at least one electric storage battery disposed within the counterweight, the battery forming at least a substantial portion of the weight of the counterweight; and
a traveling power cable extending from the counterweight, the power cable communicating electrically with and providing electrical power to the elevator drive motor.

2. The battery counterweighted elevator according to claim 1, wherein:
the elevator hoistway includes a rack extending from the lower end of the hoistway to the upper end of the hoistway;
the elevator drive motor is disposed with the elevator car, the elevator drive motor drives a pinion engaged with the rack of the elevator hoistway;
the traveling power cable extends between the counterweight and the elevator car and the elevator drive motor of the elevator car;
a traveling control and communications cable is disposed with the traveling power cable;
an electrical junction box is affixed to the elevator hoistway; and
a traveling battery charger power and communications cable extends between the junction box and the counterweight.

3. The battery counterweighted elevator according to claim 2, wherein the elevator car further includes an overspeed safety brake and speed governor system disposed therewith.

4. The battery counterweighted elevator according to claim 1, wherein:
the hoistway includes a pulley and sheave assembly disposed at the upper end thereof;
the elevator drive motor is disposed with and selectively drives the pulley and sheave assembly;
a traction cable extends upwardly from the elevator car, through the pulley and sheave assembly, and downwardly to the counterweight;
an electrical junction box is affixed to the elevator hoistway;
a traveling elevator control and communications cable extends between the elevator car and the junction box;
a traveling battery charger power and communications cable extends between the counterweight and the junction box; and
a stationary power cable extends from the junction box to the drive motor.

5. The battery counterweighted elevator according to claim 1, wherein:
an electrical junction box is affixed to the elevator hoistway, the junction box communicating electrically with the electric storage battery of the counterweight and selectively providing electrical power from the electric storage battery to the elevator drive motor; and
a solar cell array is electrically connected to the junction box and provides electrical power to the electric storage battery of the counterweight through the junction box.

6. The battery counterweighted elevator according to claim 5, wherein an electrical supply grid is electrically connected to the junction box, the electrical supply grid supplying electrical power to the junction box as required.

7. The battery counterweighted elevator according to claim 1, wherein the counterweight further includes a battery charger therewith.

8. The battery counterweighted elevator according to claim 1, further including a regenerative braking system.

9. A battery counterweighted elevator, comprising:
an elevator hoistway having an upper end and a lower end opposite the upper end;
a rack extending from the lower end of the hoistway to the upper end of the hoistway;
an elevator car disposed along the hoistway, the elevator car being adapted to travel up and down along the hoistway;
an elevator drive motor disposed on the elevator car, the elevator drive motor having a pinion engaging the rack to raise and lower the elevator car;
a counterweight connected to the elevator car, the counterweight traveling up and down in a direction opposite the elevator car;
at least one electric storage battery disposed within the counterweight, the battery forming at least a substantial portion of the weight of the counterweight;
a traveling power cable extending between the counterweight and the elevator drive motor on the elevator car, the power cable communicating electrically with and providing electrical power to the elevator drive motor;
an electrical junction box affixed to the elevator hoistway, the junction box communicating electrically with the electric storage battery of the counterweight and selectively providing electrical power from the electric storage battery to the elevator drive motor; and
a traveling battery charger power and communications cable extending between the junction box and the counterweight.

10. The battery counterweighted elevator according to claim 9, wherein the elevator car further includes an overspeed safety brake and speed governor system disposed therewith.

11. The battery counterweighted elevator according to claim 9, wherein a solar cell array is electrically connected to the junction box and provides electrical power to the electric storage battery of the counterweight through the junction box.

12. The battery counterweighted elevator according to claim 11, wherein an electrical supply grid is electrically connected to the junction box, the electrical supply grid supplying electrical power to the junction box as required.

13. The battery counterweighted elevator according to claim 9, wherein the counterweight further includes a battery charger therewith.

14. The battery counterweighted elevator according to claim 9, further including a regenerative braking system.

15. A battery counterweighted elevator, comprising:
an elevator hoistway having an upper end and a lower end opposite the upper end;
a pulley and sheave assembly disposed at the upper end of the hoistway;
an elevator drive motor connected to and selectively driving the pulley and sheave assembly;
an elevator car disposed along the hoistway, the elevator car being adapted to travel up and down along the hoistway;
a counterweight connected to the elevator car, the counterweight traveling up and down in a direction opposite to the elevator car;
a traction cable extending up from the elevator car, through the pulley and sheave assembly, and down to the counterweight;
at least one electric storage battery disposed within the counterweight, the battery forming at least a substantial portion of the weight of the counterweight;
an electrical junction box affixed to the elevator hoistway; and
a power cable electrically connected between the battery and the elevator drive motor.

16. The battery counterweighted elevator according to claim 15, wherein a solar cell array is electrically connected to the junction box and provides electrical power to the electric storage battery of the counterweight through the junction box.

17. The battery counterweighted elevator according to claim 16, wherein an electrical supply grid is electrically connected to the junction box, the electrical supply grid supplying electrical power to the junction box as required.

18. The battery counterweighted elevator according to claim 15, wherein the counterweight further includes a battery charger therewith.

19. The battery counterweighted elevator according to claim 15, further including a regenerative braking system.
